(19) United States
(12) Patent Application Publication
(10) Pub. No.: US 2015/0322358 A1
(43) Pub. Date: Nov. 12, 2015

(54) PURIFICATION OF A RAW GAS BY HYDROGENATION

(71) Applicant: Haldor Topsøe A/S, Kgs. Lyngby (DK)

(72) Inventor: Christian Wix, Nærum (DK)

(21) Appl. No.: 14/409,090

(22) PCT Filed: Jun. 27, 2013
(86) PCT No.: PCT/EP2013/063481

§ 371 Date: Dec. 18, 2014

(30) Foreign Application Priority Data
Jun. 29, 2012 (EP) PCT/EP2012/002753

(51) Int. Cl. C10K 1/34; C01B 3/58; C10K 1/00

(52) U.S. Cl. CPC C10K 1/34; C10K 1/004; C10K 1/002; C01B 3/58; C01B 2203/0435; C01B 2203/048; C01B 2203/0465

(57) ABSTRACT

The present disclosure relates to a process for hydrogenation of a raw gas feed, said process comprising the steps of a) reacting the raw gas in the presence of a material being catalytically active in hydrogenation of oxygen and/or olefins, and being an adsorbent of H₂S, and b) withdrawing a heated purified gas wherein said raw gas comprises at least 10 ppb, preferably at least 20 ppb, and most preferably at least 50 ppb of a sulfur impurity such as H₂S or COS, and at least 0.1%, preferably at least 0.2% and most preferably at least 0.5% by volume of one or more further impurities taken from the group of O₂ and CₙH₂ₙ, and wherein the temperature of the catalytically active material is sufficiently high to ensure that the concentration of the sulfur impurity and said one or more further impurities in said purified gas is less than half the concentration in said raw gas. This process has the benefit of removing multiple undesired impurities from the raw gas in a single reactor while maintaining the temperature at the outlet of the reactor sufficiently low to avoid production of alcohols.

The present invention is directed to purification of raw gas. In particular, the invention concerns removal of sulfur by adsorption and oxygen and olefins by hydrogenation.

Industrial raw gases arise typically from gasification of carbonaceous raw materials such as coal, oil petroleum coke, biomass and the like as a reformed hydrocarbon feed or as coke oven gas.

Often, such a raw gas is obtained by the gasification process or as an off gas from the production of coke, the so called coke oven gas.

These gases contain hydrogen, which inter alia is a valuable reactant for use as alternative fuel or for use in the preparation of a number of bulk chemicals and of liquid or gaseous fuels.

As an example, gasifier gas and coke oven gas may be employed in the preparation of substitute natural gas (SNG). A raw gas may also be converted into a liquid fuel, such as gasoline or diesel by the Fischer Tropsch process or by an oxygenate to gasoline process.

Olefins are undesired because they may result in deactivation of catalysts by carbon formation which may take place when heating a gas comprising olefins.

Oxygen is similarly undesired because the presence of oxygen in downstream processes may be detrimental due to local hot-spots and oxidation of reduced catalysts.

Alternatively, the raw gas may be a mixture of e.g. natural gas comprising sulfur and process tail gases comprising olefins being directed for downstream processing, such as tail gases from processes for synthesis of hydrocarbons by Fischer-Tropsch, methanol-to-gasoline, TIGAS and similar processes.

Now according to the present invention it has been realized that olefins and oxygen together may be removed by hydrogenation over a hydrogenation catalyst, such as a catalyst comprising one or more of Cu, Al ad Zn, while sulfur compounds may be adsorbed on said hydrogenation catalyst without influencing the catalytic activity.

Furthermore, for the catalytic hydrogenation either of olefins to paraffins or of oxygen to water it has been found to be successful that a temperature control may be important, since increased temperatures due to the exothermal hydrogenation reaction may result in activation of exothermal reactions e.g. the exothermal production of CH₃OH from H₂ and CO on a catalyst comprising copper, methanation on a catalyst comprising nickel or Fischer Tropsch wax formation on a catalyst comprising iron. The latter may result in a further undesired heating of the reactor, in activating the exothermal reaction such as methanol production further, and possibly also in a catalyst deactivation due to sintering of the catalyst.

It may also be a desire to control the output temperature to avoid damage of downstream equipment.

Where concentrations are stated in % this shall be understood as volumetric %.

As used herein, “raw gas” shall comprise any gas in which the combined concentration of hydrogen and carbon oxides is at least 60%.

In a broad form, the present disclosure relates to a process for hydrogenation of a raw gas feed, said process comprising the steps of
a) reacting the raw gas in the presence of a material being catalytically active in hydrogenation of oxygen and/or olefins, and being an adsorbent of H₂S, and
b) withdrawing a heated purified gas
   wherein said raw gas comprises at least 10 ppb, preferably at least 20 ppb, and most preferably at least 50 ppb of a sulfur impurity such as H₂S or COS, and at least 0.1%, preferably at least 0.2% and most preferably at least 0.5% by volume of one or more further impurities taken from the group of O₂ and CₙH₂ₙ, and wherein the temperature of the catalytically active material is sufficiently high to ensure that the concentration of the sulfur impurity and said one or more further impurities in said purified gas is less than half the concentration in said raw gas. This process has the benefit of removing multiple undesired impurities from the raw gas in a single reactor while maintaining the temperature at the outlet of the reactor sufficiently low to avoid production of alcohols. For low concentrations of sulfur compounds, the material used for capture of sulfur compounds may be the hydrogenation catalyst if it comprises a sulfur binding material known to the skilled person, such as compositions comprising ZnO.

In a further embodiment the hydrogenation process is carried out in a reactor cooled by a cooling medium with the associated benefit.

In a further embodiment the cooling medium is the raw gas, steam, water or another heat transfer medium with the associated benefit of being able to transfer heat to other process stages, such as preheating the raw gas e.g. to at least 60° C. while the reactor temperature is maintained at a low level such that undesired exothermal reactions such as formation of methanol from CO and H₂ are not activated.

In a further embodiment the raw gas further comprises less than 5% H₂O. The presence of water allows the reaction forming H₂S and CO₂ from COS and H₂O, but an excessive presence of water may shift the adsorption equilibrium ZnO+H₂S═ZnS+H2O.

In a further embodiment the cooling medium is boiling water, and the heated purified gas is withdrawn at a temperature below 250° C. with the associated benefit of the maximum temperature of the heated purified gas being well controlled due to the invariability of the boiling point.

In a further embodiment the heated purified gas is withdrawn at a temperature below 220° C., preferably below 200° C., and even more preferably below 180° C. with the associated effects of protecting equipment and catalysts and avoiding activation of undesired reactions.

In a further embodiment the material being catalytically active in hydrogenation comprises at least one active element chosen from the group consisting of Cu, Al, and ZnO, with the associated benefit of providing a material having a high hydrogenation activity.

In a further embodiment the sum of the volumetric concentration of CO and H₂ in said raw gas is at least 60% with the associated benefit of providing a synthesis gas suitable for production of synthetic natural gas or for use as a feed to a Fischer-Tropsh process or for a liquid fuel production such as a TIGAS process or a methanol production.

In a further embodiment the process further comprises contacting the raw gas with an additional sulfur capture material, which may be arranged outside the heat exchange section of the reactor. As a result, a separate zone of sulfur capture material is simpler than hitherto known to replace and compared to the catalytically active material in the reactor. The sulfur capture material may be present in the same reactor or in a separate reactor according to desire in the specific situation.

In a further embodiment the raw gas, the cooling medium and the raw gas are configured to flow in co-flow with the associated benefit of an improved control of runaway temperatures which applies especially to varying inlet temperatures or varying compositions.

In a further embodiment the raw gas, the cooling medium and the raw gas are configured to flow in counter flow with the associated benefit of an efficient cooling of the reaction while maintaining a reduced temperature of the catalytically active material, which is especially relevant in case of high concentrations of the compounds to be hydrogenated.

In a further embodiment the raw gas is pre-heated by an external heat source, such as a steam heat exchange, an electrical heating or a heat exchange with a warm process stream prior to hydrogenation with the associated benefit of being able to adjust the raw gas temperature to the optimal value. If the reactor is cooled by the raw gas, the pre-heating may be made upstream or downstream the cooling of the reactor.

A further aspect of the disclosure relates to a reactor for the production of a purified gas being configured to receive a raw gas as heat exchange medium providing a heated raw gas, where said raw gas comprises at least 10 ppb, preferably at least 20 ppb, and most preferably at least 50 ppb of a sulfur impurity such as H₂S or COS, and at least 0.1%, preferably at least 0.2%, and most preferably at least 0.5% by volume of a further impurity taken from the group of O₂ and CₙH₂ₙ, where the concentration of sulfur impurity and said further impurity in said purified gas is less than half the concentration in said raw gas, and where said reactor is further configured to direct said heated raw gas to a material being catalytically active in the hydrogenation of olefins, oxygen or both, and having an adsorption capacity for sulfur, characterized in that said reactor is configured for the material being catalytically active to be in thermal contact with a cooling medium, such as steam, water or a raw gas with the associated benefit of providing a reactor well suited for controlling the temperature of the reaction.

In a further embodiment the reactor may be configured for the raw gas to contact the material being catalytically active in hydrogenation inside tubes with the cooling medium flowing on the outer side of the tubes.

In a further embodiment the reactor may be configured for the raw gas to contact the material being catalytically active in hydrogenation on the outside of tubes with the cooling medium flowing on the inside of the tubes.

In a further embodiment the reactor further comprises one or more zones of sulfur capture material.

The invention is described in greater detail below with reference to the accompanying drawings, in which

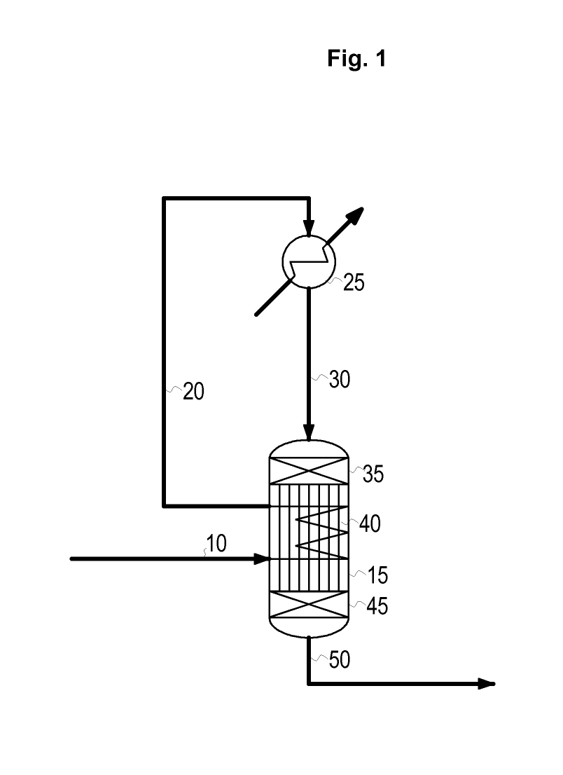

FIG. 1 illustrates a process according to a first embodiment of the disclosure, and

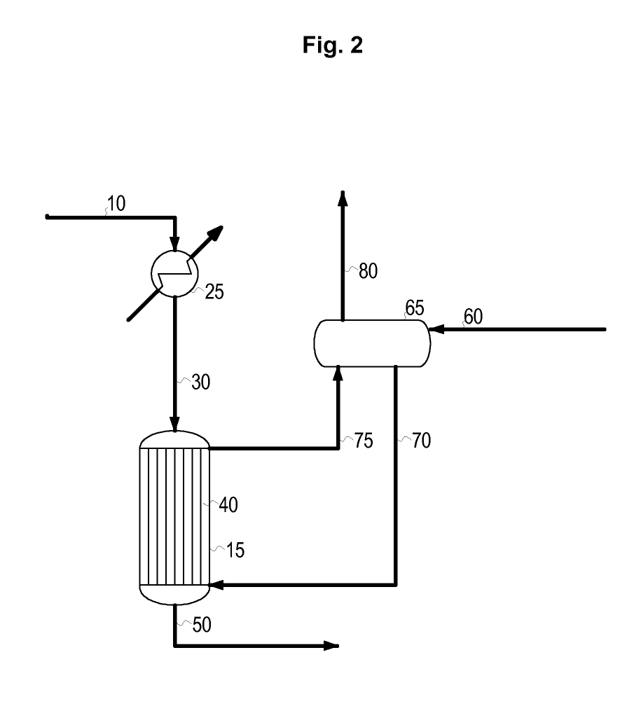

FIG. 2 illustrates a process according to a second embodiment of the disclosure.

FIG. 1 shows a specific embodiment of the disclosure, in which a raw gas 10 is fed as a heat exchange medium to a gas cooled reactor 15 and withdrawn as a first heated raw gas 20. The temperature of the heated raw gas may be further adjusted in an optional heat exchanger 25 providing a heated feed gas 30, having a temperature in the range 70-170° C. The heated feed gas 30 is then directed to contact an optional first sulfur capture material comprising ZnO and being active in adsorption or chemisorption of sulfur 35, then further to contact a catalytic material, such as Cu, Al, or ZnO being active in hydrogenation 40, and finally to contact an optional second sulfur capture material comprising ZnO and being active in adsorption or chemisorption of sulfur 45, providing a heated purified gas 50.

FIG. 2 shows a further embodiment of the disclosure in which the reactor is cooled by a steam medium. Water 60 is fed to a steam drum 65, from which water 70 is directed to the cooled reactor 40, in which the water is heated to steam 75, which is collected in the steam drum 65 from which it may be distributed in a steam line 80.

The effect of a purification process according to the present disclosure has been evaluated for the three feed compositions, and process conditions shown in Table 1.

TABLE 1

| | Example 1 | | | Example 2 | | | Example 3 | | |
|---|---|---|---|---|---|---|---|---|---|
| | | Out | Out | | Out | Out | | Out | Out |
| | Inlet | (Adiabatic) | (Gas cooled) | Inlet | (Adiabatic) | (Gas cooled) | Inlet | (Adiabatic) | (Gas cooled) |
| T (° C.) | 140.00 | 229.59 | 160.00 | 140.00 | 176.61 | 160.00 | 140.00 | 276.97 | 160.00 |
| Hydrogen | 60.20 | 59.37 | 60.37 | 63.70 | 63.12 | 63.70 | 57.50 | 55.21 | 57.21 |
| Water | 0.00 | 0.06 | 0.01 | 0.00 | 0.23 | 0.01 | 0.00 | 0.37 | 0.03 |
| Nitrogen | 0.00 | 0.00 | 0.00 | 0.10 | 0.10 | 0.10 | 1.70 | 1.79 | 1.72 |
| Carbon Monoxide | 19.03 | 17.78 | 18.48 | 19.18 | 18.95 | 19.04 | 9.50 | 7.73 | 9.05 |
| Carbon Dioxide | 0.78 | 1.38 | 1.40 | 1.32 | 1.31 | 1.52 | 2.50 | 2.93 | 3.11 |
| Argon | 0.33 | 0.34 | 0.33 | 0.10 | 0.10 | 0.10 | 0.00 | 0.00 | 0.00 |
| Methane | 19.29 | 19.82 | 19.35 | 15.20 | 15.39 | 15.24 | 25.50 | 26.87 | 25.84 |
| Ethane | 0.04 | 0.06 | 0.06 | 0.15 | 0.30 | 0.30 | 1.00 | 2.11 | 2.03 |
| Ethylene | 0.02 | 0.00 | 0.00 | 0.15 | 0.00 | 0.00 | 1.00 | 0.00 | 0.00 |
| Propane | 0.00 | 0.00 | 0.00 | 0.00 | 0.00 | 0.00 | 0.50 | 0.53 | 0.51 |
| Propylene | 0.00 | 0.00 | 0.00 | 0.00 | 0.00 | 0.00 | 0.50 | 0.53 | 0.51 |
| Oxygen | 0.31 | 0.00 | 0.00 | 0.10 | 0.00 | 0.00 | 0.30 | 0.00 | 0.00 |
| Methanol | 0.00 | 1.20 | 0.00 | 0.00 | 0.50 | 0.00 | 0.00 | 1.92 | 0.00 |
| Ethanol | 0.00 | 0.00 | 0.00 | 0.00 | 0.00 | 0.00 | 0.00 | 0.03 | 0.00 |

### EXAMPLE 1

In a first example, a feed composition comprising 0.31% oxygen was hydrogenated.

The feed gas of the first example was evaluated according to the prior art with hydrogenation in an adiabatic reactor. In this case the product gas comprised 1.20% methanol, and the temperature out of the reactor was raised to 230° C.

The feed gas of the first example was also evaluated according to the present disclosure with hydrogenation in a gas cooled reactor. In this case the product gas comprised no methanol, and the temperature was due to the gas cooling maintained at 160° C.

### EXAMPLE 2

In a second example, a feed composition comprising 0.15% ethylene was hydrogenated.

The feed gas of the second example was evaluated according to the prior art with hydrogenation in an adiabatic reactor. In this case the product gas comprised 0.50% methanol, and the temperature out of the reactor was raised to 177° C.

The feed gas of the second example was also evaluated according to the present disclosure with hydrogenation in a gas cooled reactor. In this case the product gas comprised no methanol and the temperature was maintained at 160° C. by means of gas cooling.

### EXAMPLE 3

In a third example, a feed composition comprising 0.30% oxygen, 1.00% ethylene and 0.50% propylene was hydrogenated.

The feed gas of the third example was evaluated according to the prior art with hydrogenation in an adiabatic reactor. In this case the product gas comprised 1.92% methanol, and the temperature out of the reactor was raised to 277° C.

The feed gas of the third example was also evaluated according to the present disclosure with hydrogenation in a gas cooled reactor. In this case the product gas comprised no methanol and the temperature was maintained at 160° C. by means of gas cooling.

As it is seen in the above examples, the effect of the present disclosure is an ability to control the temperature in the reactor such that the undesired production of methanol is avoided, and such that the outlet gas is maintained at a temperature of 160° C. protecting the process materials.

1. A process for hydrogenation of a raw gas feed, said process comprising the steps of
a) in a reactor cooled by a cooling medium, reacting the raw gas in the presence of a material being catalytically active in hydrogenation of oxygen and/or olefins and being an adsorbent of H₂S, and
b) withdrawing a heated purified gas,
wherein said raw gas comprises
at least 10 ppb, preferably at least 20 ppb, and most preferably at least 50 ppb of a sulfur impurity such as H₂S or COS, and
at least 0.1%, preferably at least 0.2%, and most preferably at least 0.5% by volume of one or more further impurities taken from the group of O₂ and CₙH2ₙ,
and where the temperature of the catalytically active material is sufficiently high for ensuring that the concentration of sulfur impurity and said one or more further impurities in said purified gas is less than half the concentration in said raw gas.

2. A process according to claim 1, being carried out in a reactor cooled by a cooling medium, which may be the raw gas or steam, water or another heat transfer medium.

3. The process according to claim 1, wherein the raw gas further comprises water in an amount less than 5% H₂0.

4. The process according to claim 2, wherein the cooling medium is boiling water and the heated purified gas is withdrawn at a temperature less than 250° C.

5. The process according to claim 2, wherein the heated purified gas is withdrawn at a temperature less than 220° C., preferably less than 200° C. and even more preferably less than 180° C.

6. The process according to claim 1, wherein said material being catalytically active in hydrogenation comprises at least one active element chosen from the group consisting of Cu, Al, and ZnO.

7. The process according to claim 1, wherein the sum of the volumetric concentration of CO and H₂ in said raw gas is at least 60%.

8. The process according to claim 1, said process further comprising contacting the raw gas with a sulfur capture material.

9. The process according to claim 1, wherein the cooling medium and the raw gas are configured to flow in co-flow.

10. The process according to claim 1, wherein the cooling medium and the raw gas are configured to flow in counter flow.

11. The process according to claim 1, wherein the raw gas is pre-heated by an external heat source such as a steam heat exchange, an electrical heating or a heat exchange with a warm process stream prior to hydrogenation.

12. A reactor for the production of a purified gas being configured for receiving a heated raw gas,
wherein said raw gas comprises
at least 10 ppb, preferably at least 20 ppb, and most preferably at least 50 ppb of a sulfur impurity such as H₂S or COS, and
at least 0.1%, preferably at least 0.2%, and most preferably at least 0.5% by volume of a further impurity taken from the group of O₂ and CₙH₂ₙ,
and the concentration of sulfur impurity and said further impurity in said purified gas is less than half the concentration in said raw gas,
and where said reactor is further configured for directing said heated raw gas to a material being catalytically active in the hydrogenation of olefins, oxygen or both, and having an adsorption capacity for sulfur,
wherein said reactor is configured for the material being catalytically active to be in thermal contact with a cooling medium, such as steam, water or a raw gas.

13. A reactor according to claim 12, comprising tubes containing a material being catalytically active in hydrogenation inside tubes, configured for the cooling medium flowing on the outer side of the tubes.

14. A reactor according to claim 12 comprising tubes configured for receiving the cooling medium flowing on the inside of the tubes, and configured for the catalytically active material being contained in the reactor outside the tubes.

15. A reactor according to claim 12, further comprising one or more zones of sulfur capture material.

16. A reactor according to claim 12 in which the reactor is configured for receiving a raw gas as cooling medium, providing a heated raw gas, and configured for directing the heated raw gas to contact said material being catalytically active.
